(19) United States
(12) Patent Application Publication
(10) Pub. No.: US 2026/0109481 A1
(43) Pub. Date: Apr. 23, 2026

(54) DEEP REINFORCEMENT LEARNING FOR AIRPLANE COMPONENT FAILURE PROGNOSTIC FULL CYCLE AUTOMATION

(71) Applicant: THE BOEING COMPANY, Arlington, VA (US)

(72) Inventors: Baoqian WANG, Madison, AL (US); Changzhou WANG, Bellevue, WA (US); Denis OSIPYCHEV, Madison, AL (US)

(21) Appl. No.: 18/920,724

(22) Filed: Oct. 18, 2024

(51) Int. Cl. B64F 5/60; G06N 3/044; G06N 3/092; G06Q 10/20

(52) U.S. Cl. CPC B64F 5/60; G06N 3/044; G06N 3/092; G06Q 10/20

(57) ABSTRACT

The present disclosure provides techniques for deep reinforcement learning to achieve full-cycle automation in airplane component failure prognostics. Flight data is preprocessed to identify parameters representing operational characteristics of an airplane component. A reinforcement learning framework is formulated based on the preprocessed flight, comprising defining a state representation as an input to a policy model, determining an action of sending an alert or not based on the state representation, modeling one or more system behaviors in response to the action using the preprocessed flight data, calculating a reward of the action under the state representation using a predefined reward structure, collecting training data by simulating an airplane component prognostic procedure. The policy model is trained using a learning and optimization algorithm with the training data to increase an expected discounted cumulative reward by choosing an action under the state representation.

### FIELD

Aspects of the present disclosure relate to airplane maintenance, and more specifically, to the use of deep reinforcement learning techniques to achieve full-cycle automation in the prognostics of airplane component failures.

### BACKGROUND

As airplanes accumulate operational hours, the likelihood of mechanical component failures increases. To ensure the safety operation of airplanes, airplane service organizations and airline companies collaborate on mechanical component failure prognostics to timely identify and replace malfunctioning components. In conventional methods, the operating state of airplane components is monitored by onboard sensors. These sensors collect data, which is then recorded by the avionic system during flight. Airplane service organizations analyze the collected sensor data, along with flight records, to predict potential component failures. Upon detecting a possible failure, the airplane service organization promptly sends an alert to the affected airline company. In response, the airline company conducts an inspection on the identified component to verify the problem, and, if confirmed, takes corrective actions, such as replacing the component. The action is intended to prevent any compromise in the aircraft's safety and performance.

### SUMMARY

The present disclosure provides a method in one aspect, the method including preprocessing flight data to identify a plurality of parameters representing operational characteristics of an airplane component, formulating, based on the preprocessed flight data, a reinforcement learning framework for airplane component failure prognostics, and training a policy model using a learning and optimization algorithm with training data to increase an expected discounted cumulative reward by choosing an action under a state representation. The formulating comprises defining the state representation as an input to the policy model, where the state representation comprises one or more parameters from the plurality of parameters, determining the action of sending an inspection alert or not, by the policy model, based on the state representation, modeling one or more system behaviors in response to the action using preprocessed flight data, calculating a reward for the action under the state representation using a predefined reward structure, and collecting the training data by simulating an airplane component failure prognostic procedure.

Other aspects of this disclosure provide one or more non-transitory computer-readable media containing, in any combination, computer program code that, when executed by the operation of a computer system, performs operations in accordance with one or more of the above methods, as well as systems comprising one or more computer processors and one or more memories containing one or more programs that, when executed by the one or more computer processors, perform operations in accordance with one or more of the above methods.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIG. 1 depicts an example environment for airplane component failure prognostics, according to some aspects of the present disclosure.

FIG. 2 depicts an example reinforcement learning framework for training an alert policy model for automated airplane component failure prognostics, according to some aspects of the present disclosure.

FIG. 3 depicts an example policy model for automated airplane component failure prognostics, according to some aspects of the present disclosure.

FIG. 4 depicts an example method for formulating a reinforcement learning framework for automated airplane component failure prognostics, according to some aspects of the present disclosure.

FIG. 5 depicts an example method for training and optimizing an alert policy model for automated airplane component failure prognostics, according to some aspects of the present disclosure.

FIG. 6 is a flow diagram depicting an example method for reinforcement learning-based airplane component failure prognostic automation, according to some aspects of the present disclosure.

FIG. 7 depicts an example computing device configured to perform various aspects of the present disclosure, according to some aspects of the present disclosure.

### DETAILED DESCRIPTION

In the context of airplane component failure prognostics, it is important to determine the appropriate timing for sending inspection alerts to airline companies. Incorrect alert timing may result in either missed failures, leading to unscheduled maintenance and operational disruptions, or unnecessary inspections, which impose additional maintenance burdens and costs on airline companies. Traditional approaches to making these decisions often rely on conventional data analysis techniques and manual engineering reviews, which typically require substantial human effort. Furthermore, these traditional methods do not perform well in capturing patterns within flight records and sensor data, especially given the large data volume and the presence of noise. As a result, this can lead to suboptimal alert decisions.

To address these issues, the present disclosure introduces techniques that leverage deep reinforcement learning to automate the airplane component failure prognostic process. In one aspect, the neural network model is used to represent an alert policy that takes contextual information (e.g., flight records, airline response records) as input and generates alert decisions. A simulated failure prognostic environment, constructed using historical flight data and airline response data, is built to collect training data, which is used by learning and optimization algorithm to train the alert policy model. Once trained and evaluated, the alert policy model is deployed to make real-time decisions automatically, with the ability to adapt to new component features and airline operation changes through parameter fine-tuning.

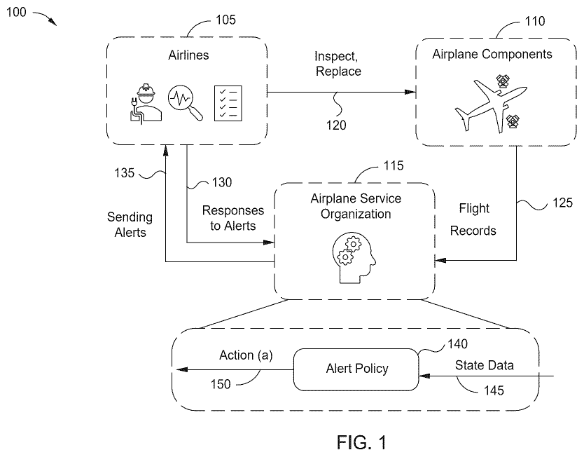

FIG. 1 depicts an example environment 100 for airplane component failure prognostics, according to some aspects of the present disclosure.

As illustrated, three entities may be involved in the airplane component failure prognostic system, including the airline company 105, the airplane component 110, and the airplane service organization 115.

Airplanes typically include a large number of components and parts (e.g., air cycle machine (ACM), engine components, landing gear components, and the like), and monitoring the operational status of these components is important for maintaining the airplane's safety and reliability. As illustrated in FIG. 1, the airplane service organization 115 monitors the operational status of the airplane components 110 by analyzing flight records 125.

In some aspects, the flight records 125 may include time-sequence data extracted from flight sensor data shared by airlines 105. Each record may include a date, flight number, and basic information about the airplane component (e.g., airplane registry number). For each airplane component, the flight records 125 may also include various information such as the number of days since the previous removal (except for the first installation on that airplane) and the number of days to the next removal (except for the last installation on that airplane). Additionally, in some aspects, the flight records 125 may include sensor data related to the component 110, and a failure prediction label obtained from a pre-built data model that takes the sensor data as input. One example of the sensor data is TT0 seconds for ACM, which indicates the time it takes for the ACM to stop completely from running. The TT0 may be used to determine whether a potential failure is imminent and if a replacement is needed. The smaller the TT0 value, the higher the probability of an ACM malfunction, and therefore the greater the likelihood that a replacement is needed.

By analyzing the data included within flight records 125, the airplane service organization 115 assesses the condition of the airplane component 110 and determines whether an alert should be sent.

If the airplane service organization 115 identifies a potential issue, it sends an alert 135 to the airline company 105. Upon receiving the alert, the airline company 105 evaluates the situation to determine whether an inspection is necessary. If the airline company 105 determines that an inspection is unnecessary—such as if recent maintenance was performed or the sensor data is considered unreliable—the airline company 105 sends a response 130 to the service organization indicating that no further action is required.

However, if the airline company 105 conducts an inspection 120 that reveals a failure in the component, the airline 105 then replaces the component and sends a response 130 to the airplane service organization 115, confirming that the alert 135 is accurate and the necessary replacement is performed. If the inspection 120 determines the component is functioning properly and no replacement is needed, the airline 105 sends back a response 130, indicating that the alert 135 is inaccurate and unnecessary.

The responses 130 may include scheduling or not scheduling inspections when an alert is received, conducting inspections immediately or with delay, the result of these inspections revealing whether the component should be replaced or maintained, and how the component's condition evolves over time based on its current state and the action taken (whether the component is replaced or not).

For making alert decisions, traditional approaches adopted by the airplane service organization 115 typically rely on conventional data analysis techniques and manual engineering reviews. These methods often require substantial human efforts to analyze large amounts of complex data, leading to potential delays in decision-making and a higher likelihood of inaccuracies. As depicted, the airplane service organization 115 in FIG. 1 utilizes a neural network model 140 to represent the alert policy and make corresponding alert decisions. The neural network model 140 is configured to take state data 145 as input and automatically generate alert decisions 150 in real-time. In some aspects, the state data 145 may include features or parameters extracted from flight records 125, such as sensor readings (e.g., TT0 seconds for ACM), failure prediction labels, the number of days since the previous removal, the number of days to the next removal, and from airline responses 130 such as historical inspection schedule and inspection results. With the deployment of the alert policy model 140, the airplane service organization 115 may produce more accurate and timely alerts with minimal (or at least reduced) human effort.

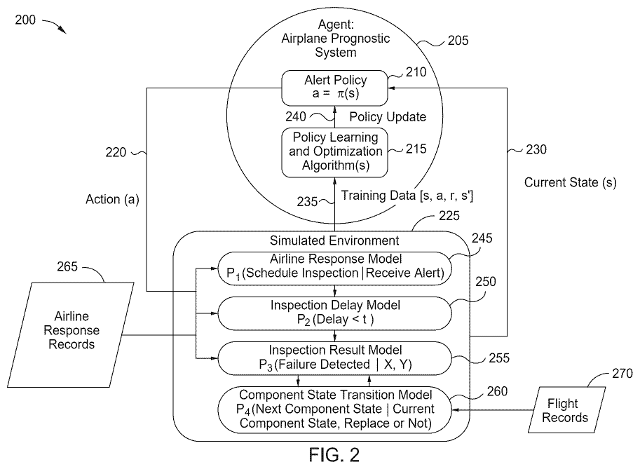

FIG. 2 depicts an example reinforcement learning framework 200 for training an alert policy model for automated airplane component failure prognostics, according to some aspects of the present disclosure.

As depicted, a Markov Decision Process (MDP) is used to formulate reinforcement learning framework 200 with policy learning and optimization algorithms 215 to train and optimize the alert policy model 210. In some aspects, the alert policy model 210 may correspond to the alert policy model 140 as depicted in FIG. 1. The MDP includes five components: state, action, policy, environment transition, and reward.

As illustrated, the airplane prognostic system 205 acts as the agent (also referred to in some aspects as the decision-maker) within this example framework 200, interacting with the simulated environment 225 and receiving feedback in the form of data tuples (state (s), action (a), reward (r), next state (s′)) 235 (also be referred as in some embodiments as training data). As illustrated, the airplane prognostic system 205 includes the alert policy 210 and the policy learning and optimization algorithm(s) 215.

The MDP consists of a sequence of steps starting from an initial state (s₀) and a terminate state (s_{T}). This sequence starting from initial state to terminate state is also called episode. In each step of an episode, the agent, representing airplane prognostic system 205, selects an action 220 based on the alert policy (a=π(s)) 210 given the state (s) 230 as input. As used herein, the alert policy 210 is defined as a function that analyzes the state data(s) 230 and generates the appropriate action (a). In the context of airplane component failure prognostics, the state (s) 230 may represent the current condition of an airplane component and other contextual information including records of alerts, inspection schedule and inspection results, and the action (a) 220 may involve deciding whether to send an alert or not. The alert policy (a=π(s)) 210 may be neural network model trained to take the state data as input and make accurate alert decisions.

In some aspects, the state (s) 230 may comprise a sequence of records, each record containing features or parameters extracted from flight data 270, such as sensor readings (e.g., TT0 seconds), the number of days since the last removal, the number of days to the next removal, failure prediction labels, and other contextual information including records of alerts, inspection schedule and inspection results.

After an action (a) 220 is determined based on the current state (s) 230, the action 220 interacts with the simulated environment 225, leading to a transition from the current state (s) to a new state (s′) based on the established environment transition model P(s′|s,a). As illustrated, four probability models 245, 250, 255, and 260 are incorporated to simulate the environment transitions, each modeling a respective system behavior.

The airline response model (P₁) 245 simulates the probability that an airline (e.g., 105 of FIG. 1) schedules an inspection after receiving an alert. Airlines operate under their own regulations and policies, and thus their responses to alerts may vary. For example, an airline may ignore an alert if recent maintenance was performed, the alert is perceived as a false positive based on historical data, or the sensor data is considered unreliable. In some aspects, the probability of scheduling an inspection upon receiving an alert may be represented as follows:

$${P}_{1} ( Schedule Inspection \vert Receive an Alert ) = \frac{Number of Inspections}{Number of Alerts}$$

In some aspects, the probability (P₁) may be estimated using historical airline response records 265, and may vary between airlines, depending on their specific policies and procedures.

In some aspects, the historical airline response records 265 may be retrieved from records documenting interactions between the airplane service organization (e.g., 115 of FIG. 1) and airline companies (e.g., 105 of FIG. 1). These records may include detailed information such as alert time, inspection schedule labels (indicating whether an inspection was scheduled following the receipt of an alert), the actual inspection time, and the inspection results (indicating whether the component failed or passed).

The inspection delay model (P₂) 250 simulates the probability of delays between the alert being sent and the inspection being performed (e.g., the difference between inspection time and alert time). In some aspects, the delay is modeled using an exponential distribution. The probability that the delay is less than a specific time t is represented as follows:

P(Delay<t)=1−exp(−λt), where λ is the rate parameter of the exponential distribution and may be estimated using Maximum Likelihood Estimation (MLE) as follows:

$$\frac{1}{λ} = \frac{S um ( Delays of Samples )}{Number of Samples}$$

In some aspects, the sum of delays and the number of samples may be estimated from historical airline response records 265. The sum of delays may be calculated by adding all the individual delay records in the historical airline response records 265 between the time an alert was sent and the time the inspection was performed. The number of samples may be determined by counting the total number of instances in the airline response records 265 where an alert was sent, and an inspection was subsequently conducted.

The inspection result model (P₃) 255 simulates the likelihood that an inspection reveals a failure in the airplane component, based on the state of the component and the timing of the inspection. The probability of detecting a failure during the inspection is influenced by factors such as the number of days since the last replacement, the operational conditions the component has been exposed to, or the delay between the alert and the actual inspection. The probability P(Failure Detected|Inspection Performed) may be modeled as a function of these factors, incorporating historical data to capture trends and patterns. For example, the likelihood of detecting a failure may increase as the inspection is performed closer to the expected failure window, or if the component has been operating under particularly stressful conditions. Additionally, the delay in conducting the inspection after an alert is sent may affect the probability, as some components may self-stabilize or degrade further during the delay period.

In some aspects, the probability P(Failure Detected|Inspection Performed) may be represented as follows:

$$P ( Failure Detected \vert X , Y ) = P ( Failure Detected \vert Y ) \times \frac{P ( X \vert Failure Detected , Y}{P ( X \vert Y )} ,$$

where X represents the inspection delay (e.g., the time between the alert time and the inspection time), and Y represents the number of days to the next scheduled removal (e.g., the expected failure window).

In some aspects, the P(Failure Detected|Y) may be modeled using an exponential distribution and represented as follows:

$$P ( Failure Detected \vert Y ) = 1 - exp ( - {λ}_{2} Y )$$

In some aspects, λ₂ may be estimated from historical airline response records 265 by analyzing failure rates in relation to the expected removal time. Specifically, λ₂ may be calculated as:

$${λ}_{2} = - \frac{ln ( 1 - P ( Failure Detected \vert Y = {y}_{0} )}{{Y}_{0}} ,$$

where P(Failure Detected|Y=y₀) represents the probability of detecting a failure when there are y₀ days remaining until the next scheduled removal. Thus, the probability P(Failure Detected approximated as:

$$P ( Failure Detected \vert Y ) = {y}_{0} ) \approx \frac{Number of “ Failure Detected ” Inspection with Y \leq {y}_{0}}{Number of Inspection with Y \leq {y}_{0}}$$

The ratio

$$\frac{P ( X \vert Failure Detected , Y )}{P ( X \vert Y )}$$

is used to adjust the base probability by considering the effect of the inspection delay on the likelihood of detecting a failure. In some aspects, the ratio may be approximated as:

$$\frac{P ( X \vert Failure Detected , Y )}{P ( X \vert Y )} \approx \frac{P ( X \vert Failure Detected )}{P ( X )} =$$

$$\frac{Number of “ Failure Detected ” Inspection with X \leq x}{Number of “ Failure Detected ” Inspection}$$

In some aspects, the ratio

$$\frac{P ( X \vert Failure Detection , Y )}{P ( X \vert Y )}$$

may be calculated using historical airline response records 265 to estimate the number of “Failure Detected” inspections with delays less than or equal to a certain threshold x, relative to the total number of “Failure Detected” inspections.

Since the state of an airplane component may change over time due to operational factors, the simulated environment 225 also relies on a component state transition model 260 to process sequential flight records 270 and capture the evolving condition of the airplane components. The component state transition model 260 simulates the probability of the component transitioning to a new state given its current state and the action taken (e.g., whether the component is replaced or not), may be represented as P(Next Component State|Current Component State, Action)

In some aspects, the component state transition model 260 may track the component's state by identifying patterns in the data, such as trends in sensor readings or operational parameters. For example, increasing friction in an ACM leading to a faster decrease in TT0 time may indicate a gradual degradation of the component. By analyzing these patterns or trends, the component state transition model 260 updates the transition probability (P₄). The incorporation of the component state transition model 260 allows the simulated environment 225 to consider the natural wear and tear on components, resulting in more accurate predictions of their operational status.

In some aspects, the component state transition model 260 may handle two special scenarios within the simulated environment 225. In the first scenario, a simulated inspection results in a “Failure” outcome. However, the real historical flight records indicate that the component continued to be used after the simulated inspection. In this configuration, the model 260 may update the next state (s′) to reflect the immediate replacement of the component and terminate the current lifecycle, even if historical data suggests continued usage. This action ensures that the simulation accurately reflects the real-world procedures of replacing a failed component rather than allowing its continued use. The second scenario occurs when a simulated inspection results in a “Passed” outcome, but there are no remaining real historical flight records for that component's lifecycle. In this configuration, the model 260 may update the next state (s′) to indicate the end of the component's lifecycle and terminate further state transitions. This action guarantees that the simulation does not attempt to predict future states or inspections beyond the available historical data.

After defining the four probabilistic models (e.g., the airline response model 245, the inspection delay model 250, the inspection result model 255, and the component state transition model 260), the simulated environment 225 integrates these elements to determine the state transition probability P(s′|s, a) to simulate the evolving of airplane component failure prognostic procedure. An episode consisting of a sequence of states and actions with a terminate state indicating removal of airplane component is used to simulate the lifecycle of airplane component.

After the agent (e.g., the airplane prognostic system 205) takes an action (a) 220, such as sending an alert, the airline response model 245 determines the probability that the airline will schedule an inspection in response. This probability (P₁) directly influences the likelihood of transitioning to a state where an inspection is either scheduled or ignored, contributing to the overall transition to the next state (s′). If the inspection is scheduled, the inspection delay model 250 then estimates the probability distribution of the delay before the inspection is conducted. The delay impacts the state transition by influencing when the inspection occurs relative to the component's condition. The delay probability (P₂) assists in defining timing of the inspection in the episode. Once the inspection is performed, the inspection result model 255 estimates the probability of detecting a failure based on the state of the component and the delay before the inspection. The probability (P₃) determines whether the component is found to be a failed state or not, further influencing the transition to the new state (s′). The probability (P₄) reflects how the component's condition is likely to change based on its current state and whether it is replaced. The transition probability P(s′|s, a) represents the likelihood of moving from the current state (s) to a new state (s′) after taking a particular action (a). In some aspects, the transition probability P(s′|s, a) may be calculated by considering the combined effects of the transition probabilities (e.g., P₁, P₂, P₃, P₄) together.

In some aspects, the reward (r) in each step for taking an action 220 (a) in a given state 230 (s) may be determined by a predefined reward structure. In the context of airplane component failure prognostics, an example reward structure may be defined as follows: sending an alert results in a small negative reward of −1; if the alert is sent with an inspection already scheduled in response to previous alert and is not performed yet, a small negative reward like −2 is issued to avoid such unnecessary alerts; if the alert triggers an inspection that finds the component is functioning properly, a large negative reward like −5 is issued, penalizing the unnecessary inspection; if the alert triggers an inspection that reveals a failure or if the alert is sent within 30 days of component failure even if there is no inspection, a large positive reward like +10 is assigned, as the alert correctly predicted a component issue; and finally, if a failure occurs without an alert being sent, there is a significant penalty, such as −10.

As illustrated, the data 235 collected from the simulated environment, including the current state (s), next state (s′), action (a), and reward (r(s,a)), are provided to the policy learning and optimization algorithm 215. The policy learning and optimization algorithm 215 is used to train the alert policy model 210 by refining its decision-making process. Examples of the policy learning and optimization algorithms 215 may include Deep Q-Network (DQN) or Deep Deterministic Policy Gradient (DDPG). In some aspects, the policy learning and optimization algorithm 215, like DQN, may estimate the expected discounted cumulative reward (also referred to in some embodiments as Q-value) for different initial actions and states, which captures the potential long-term benefits of taking certain actions in a state. By comparing the Q values for these different actions (e.g., sending or not sending an alert) given a state, the algorithm 215 may determine which action are most likely to maximize (or at least improve) the Q value. Based on this comparison, the policy learning and optimization algorithm 215 may then provide updates 240 to the alert policy 210 (a=π(s)), guiding the model to favor actions that lead to higher Q value given a state.

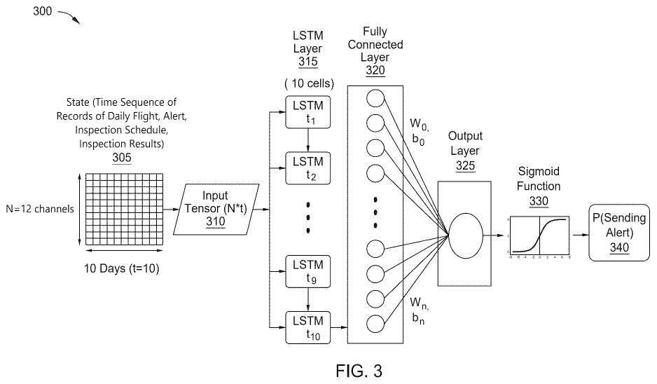

In some aspects, the alert policy 210 may be represented by a Long Short-Term Memory (LSTM) neural network model with fully connected layers, as discussed in more detail in FIG. 3. In this configuration, the training and/or learning process may involve adjusting the weights of nodes within these layers to optimize the policy's performance. As the training progresses, the alert policy 210 becomes more refined, making more accurate decisions about when to send alerts based on the evolving state data 230.

In some aspects, reward sparsity may be present in the example MDP 200 for training the alert policy 210. This is because a positive reward is only received when a successful alert is issued, which is an event that typically occurs just once within the entire lifecycle of an airplane component. This sparse reward setting makes it challenging to effectively learn the optimal decision-making policy, as the agent (e.g., the airplane prognostic system 205) has limited opportunities to receive feedback on the success of its actions. To address this issue, in some aspects, the prioritized replay buffer techniques may be implemented in the learning process. This technique prioritizes training data samples based on their importance, which is quantified by the temporal difference (TD) error. As used herein, the TD error refers to the difference between the current estimation of Q value and the updated estimation of Q value. The TD error may highlight instances where the agent's actions have significant impact on Q value. By training the policy model using these high-error samples, the learning process is in the direction of making significant improvements in estimating Q value function, and thus more effective, despite the sparse reward environment.

In some aspects, flight records 270 and/or airline response records 265 may be preprocessed before being used in the reinforcement learning framework 200. As discuss above, flight records 270 may consist of time-sequence data that includes sensor information shared by airlines (e.g., 105 of FIG. 1) across their operation time. Each record may include important details, such as the date, flight number, airplane registry number, as well as parameters representing the operational status of an airplane component, such as the number of days since the component's previous removal, the number of days until the next scheduled removal, one or more sensor readings (e.g., TT0 seconds), and failure prediction labels. However, in some aspects, flight records may be out-of-sequence, contain noise data, or have missing data for some features (e.g., the number of days since the previous removal). To improve the efficiency of training or implementing the alert policy model, the flight records 270 may be preprocessed to make them clean and ready for use.

In some aspects, a filter may be applied to identify and remove records that lack data for certain features. In some aspects, techniques such as time-series anomaly detection may be used to detect out-of-sequence data, where algorithms compare the timestamps and expected order of records to identify any discrepancies. In some aspects, statistics methods like z-score analysis may be used to detect noise data (e.g., errors or outliners) in the records. Any other suitable techniques may also be applied to remove anomalies that could distort the model's training and learning process.

In some aspects, preprocessing may also involve extracting individual lifecycles of components from the flight records, which further improves the training efficiency and accuracy. A complete lifecycle of a component may be identified by examining flight records in chronological order to determine when a component's lifecycle begins and ends. In some aspects, the end of a component's lifecycle may be identified by one of the following conditions: a change in airplane registry number, a decrease in the number of days since the previous removal, or an increase in days until the next removal. More specifically, if the registry number in the current flight differs from the next one, it suggests that the component has been transferred to a new airplane, indicating the end of its lifecycle in the current airplane. For a given airplane component, the number of days since its last removal should continually increase, while the number of days until the next scheduled removal should continually decrease. If the number of days since its last removal starts decreasing, or the number of days until the next scheduled removal starts increasing, it suggests that the component has likely been replaced, signaling the end of that lifecycle. This preprocessing of flight records ensures that the alert policy model 210 and/or component state transition model 260 receive high-quality and reliable data, leading to more effective training and decision-making in the reinforcement learning framework.

In some aspects, the airline response records 265 may be preprocessed in a similar manner to the flight records 270, including steps such as filtering out incomplete records, detecting out-of-sequence data to maintain the correct chronological order of events, and removing noise that could distort the simulation results. Techniques such as anomaly detection, statistical analysis, and sequence alignment may be applied to these records to identify and correct any inconsistencies. Since the simulated environment 225 relies on these records 265 to model real-world interactions between the airplane service organization (e.g., 115 of FIG. 1) and airline companies (e.g., 105 of FIG. 1), high-quality historical data generated through preprocessing may allow the simulation to accurately reflect past decisions, responses, and inspection outcomes, therefore improving the training of the alert policy model.

FIG. 3 depicts an example policy model 300 for automated airplane component failure prognostics, according to some aspects of the present disclosure.

As illustrated, the example policy model 300 is designed to analyze time-series data 305 and generate a probability of sending an alert 340. The policy model 300 may correspond to the alert policy model 140 as depicted in FIG. 1, or the alert policy model 210 as depicted in FIG. 2.

The policy model consists of an LSTM layer 315, one or more fully connected layer(s) 320 (also referred as hidden layers in some aspects), an output layer 325, and a sigmoid activation function 330. As depicted, state 305 is used as input to policy model, which may include time-sequence information that reflects the operational status of an airplane component, including, but not limited to, sensor readings (e.g., TT0 seconds), failure prediction labels, the number of days since the last component removal, and the number of days until the next scheduled removal, and records of alerts, inspection schedule and inspection results. Each parameter represents a channel or feature within the input data. In this figure, the input data is shown to have 12 channels (indicating 12 features or parameters) and spans 10 sequential time steps (10×1 day=10 days). In some embodiments, the state data 305 may include time sequence of records of daily flight, alerts, inspection schedules, and inspection results.

As depicted, the input data is first converted into an input tensor 310 with dimensions N×t, where “N” represents the number of channels (e.g., 12) and “t” represents the sequential time steps (e.g., 10 days). This conversion enables the LSTM layer 315 to handle multiple channels of information across several time steps simultaneously. The input tensor 310 is then fed into the LSTM layer 315, which is designed to capture and learn temporal dependencies across the time steps. The LSTM layer comprises 10 cells, each corresponding to one of the time steps, allowing the model to process the sequence of data and understand patterns over the 10-day period.

The output from the LSTM layer 315 is then passed to the one or more fully connected layer(s) 320 (also referred as hidden layers in some aspects). Each fully connected layer contains multiple neurons (e.g., 128 neurons) that process the temporal features extracted by LSTM layer 315. Each neuron applies a different weight (w) and bias (b) to its input, and produces intermediate output to refine the information. These intermediate outputs are then provided to the output layer 325, which consists of a single neuron. The output layer 325 integrates the information from the fully connected layer(s) 320 and combine the weighted outputs into a final value that represents the aggregated decision-making signal.

Following the integration, the final value is passed through the sigmoid activation function 330, which converts the final value into a probability 335. As depicted, the probability 335 indicates the likelihood of sending an alert based on the processed input data. In some aspects, the continuous output from the sigmoid activation function 330 may be transformed into a binary decision using an else-if condition. For example, the else-if condition may be set as sending an alert if the output of the sigmoid function falls within the range of [0.5, 1], and not sending an alert if the output of the sigmoid function falls within the range of [0, 0.5).

In some aspects, the output layer 325 may include two neurons instead of one. In this configuration, each neuron may correspond to a different action: one neuron may output a value associated with action 1 (e.g., sending an alert), and the other neuron may output a value associated with action 2 (e.g., not sending an alert). After processing the intermediate outputs from the fully connected layer(s) 320, these two nodes generate their respective values. The outputs of these two neurons may then be fed into an argmax activation function, which selects the neuron with the higher output values. The action corresponding to the selected neuron is determined as the final action. For example, if the value associated with sending an alert (action 1) is greater than the value associated with not sending an alert (action 2), the argmax activation function may output an action of sending an alert. Conversely, if the value for not sending an alert (action 2) is higher the value associated with sending an alert (action 1), the argmax activation function may output an action of not sending an alert. This approach allows the model to make a binary decision based on the comparative evaluation of both potential actions.

In some aspects, the example alert policy 300 may correspond to the alert policy model 210 as depicted in FIG. 2. In FIG. 2, a reinforcement learning framework 200, such as MDP, is applied where the alert policy model 210 improves its performance based on policy updates 240 received from the policy learning and optimization algorithm(s) 215. Examples of these algorithms include DQN for alert policy models that generate discrete outputs (e.g., “1” for sending an alert, and “0” for not sending an alert), and DDPG for models that generate continuous outputs (e.g., P(Sending Alert) 340). As depicted in FIG. 2, the policy learning and optimization algorithm 215 receives training data 235 from the simulated environment 225. The training data 235 may include the current state (s), action (a), reward (r(a,s)) and next state (s′). The training data 235 may be generated through interactions with the simulated environment, where the agent (the alert policy model) takes an action given a state, gets a reward and transit to next state. The policy learning and optimization algorithm 215 uses these data to provide a policy update 240 that guides the alert policy model's learning to maximize (or at least improve) the Q value for given action and state.

In some aspects, the learning/training process may involve iteratively adjusting the model's internal parameters, such as the weights (w₀) of the nodes in the fully connected layer 320 and potentially other layers like the LSTM layer 315. During these adjustments, gradient-based optimization may be implemented to minimize (or at least reduce) the error between the estimated Q-value and the optimal Q-value. The objective is to fine-tune these weights so the model's output more accurately reflects the optimal action for each state (e.g., the action that maximizes (or at least improves) the Q value). For example, if the Q value for sending an alert in a certain state is higher than not sending one, the model may be tuned by adjusting one or more internal weights to favor the action of sending an alert. When the model outputs a binary classification, the model may be trained to output the decision to send an alert (e.g., outputting “1”) based on the state data. In contrast, if the model generates continuous probability outputs, the model may be trained to increase the probability of sending an alert, such as by making it exceed 0.5 to trigger the alert.

In some aspects, after the alert policy model 300 is trained, the model's performance may be further evaluated using one or more evaluation metrics, such as precision, recall, and inspection redundancy. As used herein, the precision refers to the ratio between the number of successful alerts and the total number of alerts sent by the model. The precision indicates how often the alerts generated by the alert policy model are effective in identifying actual component failures. As used herein, the recall refers to the ration between the number of airplane component failures that are successfully alerted and the total number of failures. The recall indicates how often the model successfully identifies and alerts potential failures before they occur. As used herein, the inspection redundancy refers to the ration between the number of unnecessary inspections (those conducted on components that passed due to misalerts) and the total number of inspections performed by the airline. The inspection redundancy helps to assess how often the model's alerts lead to unnecessary maintenance actions, which can be costly and inefficient.

In some aspects, the alert policy model 300 may be ready for deployment when it achieves high precision and recall scores while maintaining low inspection redundancy. Once the policy 300 is learned in the simulated environment (e.g., 225 of FIG. 2) and evaluated based on these metrics, the model 300 may then be deployed to real-time airplane component failure prognostic procedures, where records of daily flight, historical alerts, inspection schedule, historical inspection results, along with previous records (e.g., up to “M” records in total, where “M” is determined by pre-defined service rules and past operational experience), may be provided as input 305 to the alert policy model. The model may then analyze the data to generate real-time alerts.

Additionally, in some aspects, as new records of flight (e.g., 270 of FIG. 2) and airline responses (e.g., 265 of FIG. 2) are being collected during the deployment, the environment models (e.g., airplane response model 245, inspection delay model 250, and inspection result model 255 of FIG. 2) may be updated with the new data. This allows for continuous training of the alert policy model 300 (or 210 of FIG. 2) within the updated environment (e.g., 225 of FIG. 2), maintaining the alert policy model adapts to new data and evolving operational conditions.

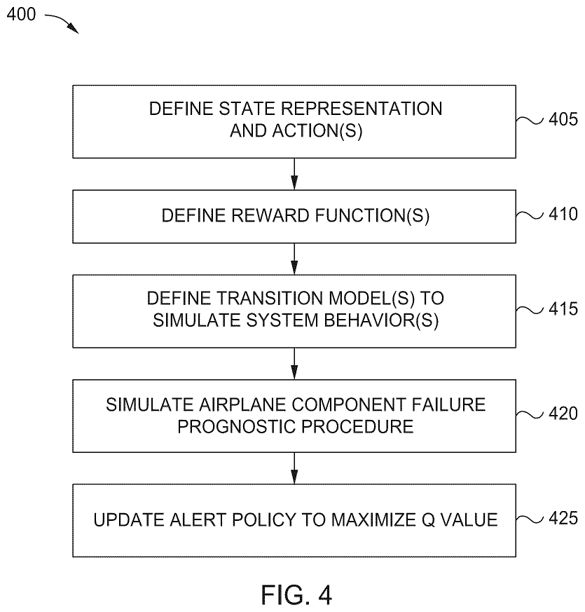

FIG. 4 depicts an example method 400 for formulating a reinforcement learning framework for automated airplane component failure prognostics, according to some aspects of the present disclosure. In some aspects, the method 400 may be performed by one or more computing devices configured to conduct automated airplane component failure prognostics. These computing devices may include local servers and/or cloud-based platforms, depending on the operational requirements and the scale of data processing needed.

At block 405, a computing device defines the state (s) and action (a) within a reinforcement learning framework (e.g., MDP). In the context of airplane component failure prognostics, the state (s) (e.g., 230 of FIG. 2) may be defined as a representation of the current condition of an airplane component, including parameters such as sensor readings (e.g., TT0 seconds), days since last removal, days to the next removal, failure prediction labels, and other relevant contextual data including records of alerts, inspection schedule, inspection results. The action (a) (e.g., 220 of FIG. 2) may be defined as the decision to either send an alert to airlines or not send an alert based on the current state.

At block 410, the computing device defines the reward function (r) within the reinforcement learning framework, which quantifies the outcome of taking a particular action in a given state. In the context of airplane component failure prognostics, positive rewards may be given when the alert correctly predicts a failure (e.g., a successful alert leading to timely replacement), and negative rewards may be given when the alert is unnecessary or if a failure occurs without an alert (e.g., missed failures or unnecessary inspections).

At block 415, the computing device defines environment transition models, which simulate the behavior of the system over time as it transits from one state to another. In some aspects, the environment transition models may consist of an airplane response model (e.g., 245 of FIG. 2), an inspection delay model (e.g., 250 of FIG. 2), an inspection result model (e.g., 255 of FIG. 2), and a component state transition model (e.g., 260 of FIG. 2). The airplane response model may simulate whether an airline will schedule an inspection after an alert, the inspection delay model may simulate the delay between receiving an alert and conducting an inspection, the inspection result model may simulate the detection of a failure based on the component's state and inspecting time, and the component state transition model may simulate the component's transition to a new state given its current state and the action taken (whether the component is replaced or not).

At block 420, the computing device generates transition probabilities (P(s′|s, a)), which represent the likelihood of moving from the current state (s) to the next state (s′) given the action (a).

At block 425, based on the transition probability model, state, reward and action, the computing devices simulate airplane failure component prognostic procedure to collect episodes (lifecycles of airplane component) with each episode consisting a sequence of data tuple (state, action, reward, next state), the computing devices then adopt a policy learning and optimization algorithm (e.g., DQN, DDPG) to train the alert policy using the collected data tuples. The alert policy is updated to favor actions that maximize (or at least improve) Q value.

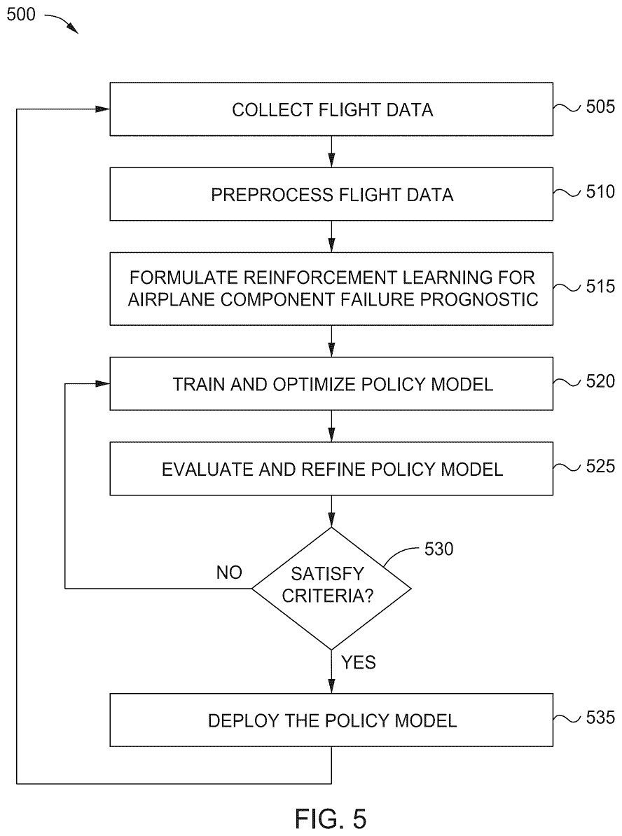

FIG. 5 depicts an example method 500 for training and optimizing an alert policy model for automated airplane component failure prognostics, according to some aspects of the present disclosure. In some aspects, the method 500 may be performed by one or more computing devices configured to conduct automated airplane component failure prognostics (e.g., including monitoring airplane components, processing flight and interaction data, and generating alerts). These computing devices may include local servers and/or cloud-based platforms, depending on the operational requirements and the scale of data processing needed. The airplane prognostic system (e.g., 205 of FIG. 2) may utilize the example method 500 to train and optimize its alert policy model (e.g., 210 of FIG. 2) for improved performance and accuracy.

At block 505, a computing device collects flight data for policy learning and optimization. In some aspects, the flight data may include flight records (e.g., 270 of FIG. 2) shared by airline companies (e.g., 105 of FIG. 1), and/or airline response records (e.g., 265 of FIG. 2) between the airplane service organization (e.g., 115 of FIG. 1) and airline companies. In some aspects, as discussed above, flight records may include time-sequence data, where each record contains a variety of parameters that represent the operational status of an airplane component. These parameters may include the number of days to the next removal, the number of days since the previous removal, various sensor data (e.g., TT0 seconds, which indicates the number of seconds it takes for an ACM to stop completely), and failure prediction labels.

At block 510, the collected flight data is preprocessed to improve its quality and reliability. In some aspects, the preprocessing process may involve filtering out incomplete records that lack data for certain features (e.g., the number of days to the next removal), detecting and correcting out-of-sequence data to maintain the correct chronological order, and removing noise (e.g., errors or outliners) that could distort the analysis. Additionally, in some aspects, individual lifecycles may be extracted from the flight records during the preprocessing. This may involve examining the data in chronological order to identify when a component's lifecycle begins and ends. By focusing on complete and accurate lifecycle data, the training process becomes more efficient with improved accuracy.

At block 515, the computing device formulates a reinforcement learning framework, specifically for training and optimizing the alert policy model (e.g., 210 of FIG. 2) within the airplane prognostic system. In some aspects, a MDP may be used, and the formulation may include defining the states, actions, rewards, and environment transition models to simulate the operational environment and guide the learning process. In the context of airplane component failure prognostics, the state may represent the current condition of the airplane component and other contextual information including records of alerts, inspection schedule and inspection results, the action may include whether to send an alert, and the environment transition models simulate the behaviors of the system over time (e.g., scheduling or not scheduling inspections, conducting inspections immediately or with delay, the result of these inspections revealing whether or not the component should be replaced or maintained, and how the component's condition evolves based on its current state and the action taken).

At block 520, the alert policy is trained and optimized using the formulated reinforcement learning framework. In some aspects, the alert policy model may be a neural network model (e.g., 300 of FIG. 3) that consists of an LSTM layer (e.g., 315 of FIG. 3), one or more fully connected layers (e.g., 320 of FIG. 3), and an output layer (e.g., 325 of FIG. 3). In some aspects, the training process may include iteratively adjusting the model's internal parameters (e.g., the weights of the nodes in the LSTM and fully connected layers) to maximize (or at least improve) the expected discounted cumulative reward (also referred to in some embodiments as Q value). The alert policy model may learn to make accurate and timely alert decisions by evaluating the outcomes of various actions in different states and refining its policy accordingly.

At block 525, once the model is trained, the model's performance is evaluated using one or more metrics. In some aspects, the metrics may include precision (the ratio of successful alerts to total alerts), recall (the ratio of successfully alerted failures to total failures), and inspection redundancy (the ratio of unnecessary inspections to total inspections). These metrics may help to assess the model's effectiveness in generating reliable alerts while minimizing (or at least reducing) false positives and unnecessary inspections.

At block 530, the computing device checks whether the model meets the predefined criteria based on the evaluation metrics. An alert policy model may be considered as performing well when it has high precision and recall scores while maintaining low inspection redundancy. In some aspects, specific criteria may be established by setting thresholds for each of these metrics. If the model's precision and recall exceed their respective thresholds, and the model's inspection redundancy is lower than the defined threshold, the model is considered to be performing well and is ready for deployment. In this configuration, the method 500 proceeds to block 535. If any of these criteria are not met, the method 500 loops back to block 520 for further training and optimization.

At block 535, the alert policy model is deployed for actual use in the airplane component failure prognostics procedures. The model is used to analyze real-time flight data received from airlines and decide actions accordingly (e.g., sending or not sending an alert). Additionally, as new flight records and airline response records are continuously collected, the environment models may be updated, and the policy may be retrained through the reinforcement learning process to adapt to new data and evolving operation conditions.

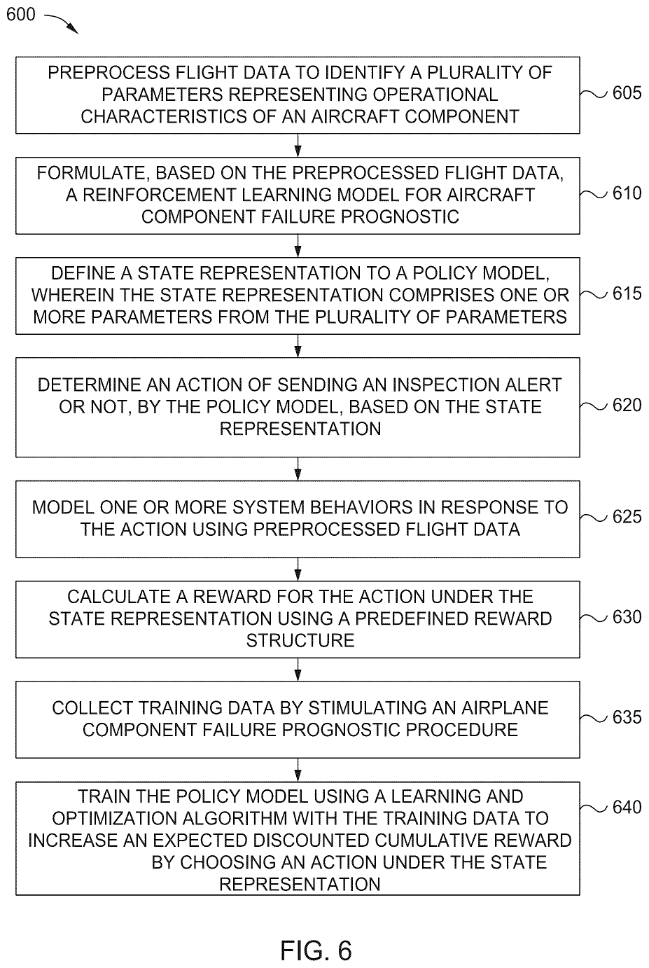

FIG. 6 is a flow diagram depicting an example method 600 for reinforcement learning-based airplane component failure prognostic automation, according to some aspects of the present disclosure.

At block 605, a computing device preprocesses flight data (e.g., flight records 270 or airline response records 265 of FIG. 2) to identify a plurality of parameters representing operational characteristics of an airplane component.

In some aspects, the plurality of parameters identified from preprocessing the flight data comprise at least one of: (i) sensor data indicative of an operational status of the airplane component; (ii) a number of days since a last removal of the airplane component; (iii) a number of days until a next scheduled removal of the airplane component; (iv) a failure prediction label generated by a prediction model; (v) one or more flight records associated with an aircraft comprising the airplane component; (vi) one or more alert times indicating when inspection alerts were sent; (vii) one or more inspection schedules indicating when inspections were scheduled; (viii) one or more inspection records indicating when the inspections were performed; and (ix) one or more inspection records indicating results of the inspections, including whether the airplane component requires replacement or maintenance.

At block 610, the computing device formulates a reinforcement learning framework (e.g., 200 of FIG. 2) for airplane component failure prognostics based on the preprocessed flight data.

Within the formulation of the reinforcement learning framework, multiple steps are performed. At block 615, the computing device defines a state representation (e.g., 230 of FIG. 2) as an input to a policy model (e.g., 210 of FIG. 2), where the state representation comprises one or more parameters from the plurality of parameters. At block 620, the computing device determines an action of sending an inspection alert or not (e.g., 220 of FIG. 2), by the policy model, based on the state representation. At block 625, the computing device models one or more system behaviors in response to the action using the preprocessed flight data. At block 630, the computing device calculates a reward for the action under the state representation using a predefined reward structure. At block 635, the computing device collects training data by simulating an airplane component failure prognostic procedure.

At block 640, the computing device trains the policy model using a learning and optimization algorithm with the training data to increase an expected discounted cumulative reward by choosing an action under the state representation. In some aspects, to train the policy model, the computing device may, given the training data, estimate the expected discounted cumulative reward under the state representation for two actions, wherein a first action comprises sending the inspection alert, and a second action comprises not sending the inspection alert. The computing device may perform a gradient-based optimization to adjust the policy model to select an action with a higher expected discounted cumulative reward under the state representation.

In some aspects, the policy model may comprise a neural network architecture that consists of a recurrent layer (e.g., 315 of FIG. 3), one or more fully connected layers (e.g., 320 of FIG. 3) and an output layer (e.g., 325 of FIG. 3).

In some aspects, performing the gradient-based optimization may comprise adjusting one or more weights of nodes within the recurrent layer or the one or more output layers to increase a likelihood of selecting the action with a higher expected discounted cumulative reward under the state representation.

In some aspects, the one or more system behaviors comprise at least one of: (i) scheduling an inspection in response to receiving the inspection alert; (ii) not scheduling an inspection in response to receiving the inspection alert; (iii) delaying the inspection for a number of days after the inspection is scheduled; (iv) generating a positive inspection result indicating that the airplane component needs to be replaced or maintained; (v) generating a negative inspection result indicating that no replacement or maintenance is needed for the airplane component; and (vi) transiting to a new state of the airplane component based on a current state of the airplane component and whether replacement is performed or not.

In some aspects, the computing device may further evaluate performance of the policy model using at least one of: a ratio between a number of successful inspection alerts and a total number of inspection alerts generated by the policy model, a ratio between a number of airplane component failures that are successfully alerted and a total number of airplane component failures, or a ratio between a number of unnecessary inspection alerts and a total number of inspections conducted.

In some aspects, the computing device may further deploy the policy model in a real-time prognostic environment, including receiving state data representing real-time operational characteristics of the airplane component, outputting an action of sending an inspection alert or not based on the state data, collecting data on one or more responses from one or more airlines and one or more airplane component statuses after executing the action, updating one or more system models based on the collected data, and refining the policy model based on the collected data.

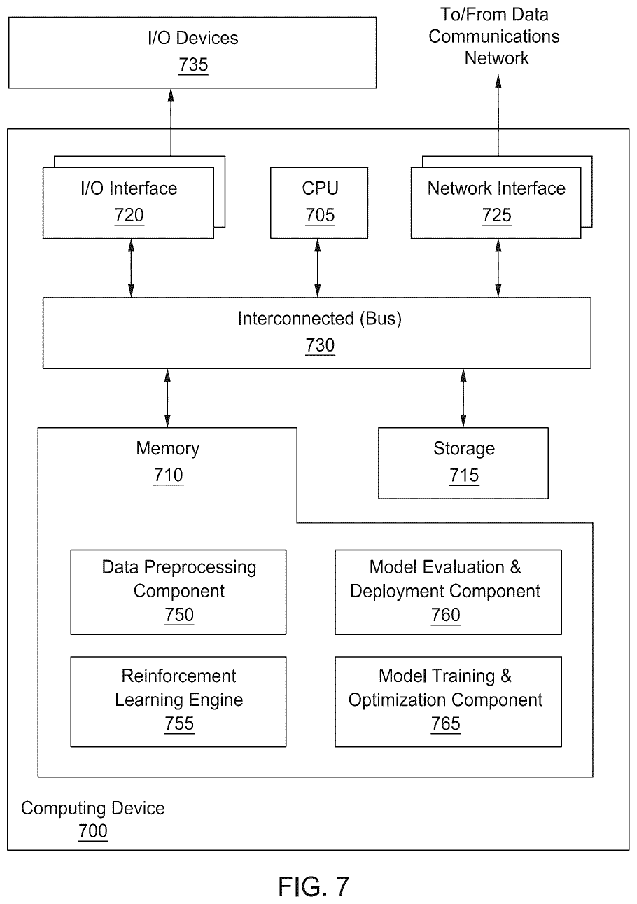

FIG. 7 depicts an example computing device 700 configured to perform various aspects of the present disclosure, according to some aspects of the present disclosure. Although depicted as a physical device, in some aspects, the computing device 700 may be implemented using virtual device(s), and/or across a number of devices (e.g., in a cloud environment).

As illustrated, the computing device 700 includes a CPU 705, memory 710, storage 715, one or more network interfaces 725, and one or more I/O interfaces 720. In the illustrated aspect, the CPU 705 retrieves and executes programming instructions stored in memory 710, as well as stores and retrieves application data residing in storage 715. The CPU 705 is generally representative of a single CPU and/or GPU, multiple CPUs and/or GPUs, a single CPU and/or GPU having multiple processing cores, and the like. The memory 710 is generally considered to be representative of a random access memory. Storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some aspects, I/O devices 735 (such as keyboards, monitors, etc.) are connected via the I/O interface(s) 720. Further, via the network interface 725, the computing device 700 can be communicatively coupled with one or more other devices and components (e.g., via a network, which may include the Internet, local network(s), and the like). As illustrated, the CPU 705, memory 710, storage 715, network interface(s) 725, and I/O interface(s) 720 are communicatively coupled by one or more buses 730.

In the illustrated aspect, the memory 710 includes a data preprocessing component 750, a reinforcement learning engine 755, a model training & optimization component 760, and a model evaluation & deployment component 765. Although depicted as discrete components for conceptual clarity, in some aspects, the operations of the depicted components (and others not illustrated) may be combined or distributed across any number of components. Further, although depicted as software residing in memory 710, in some aspects, the operations of the depicted components (and others not illustrated) may be implemented using hardware, software, or a combination of hardware and software.

In one aspect, the data preprocessing component 750 may handle the collection and preprocessing of flight data (including flight records and/or airline response records) for model training and optimization. The preprocessing may include filtering out incomplete records, detecting out-of-sequence data, removing noise data, and extracting component lifecycles. In one aspect, the reinforcement learning engine 755 may implement a reinforcement learning framework (e.g., MDP). The reinforcement learning engine 755 may define the representation of states and actions within the learning framework, model environment transitions, calculate reward and simulate airplane component failure prognostic procedure. Based on the states, actions, and immediate rewards, the reinforcement learning engine 755 may further use training algorithm like DQN or DDPG to estimate Q value and update the alert policy model. In one aspect, the model training & optimization component 760 may train and optimize the alert policy model based on data tuples (state, action, next state, reward) received from the reinforcement learning engine 755. In aspects where the alert policy model is a neural network model, such as one consisting of LSTM layers and fully connected layers, the training process may involve gradient-based optimization to adjust the weights of the nodes in these layers. The adjustment is configured to fine-tune the model's output, enabling the model to generate actions that yield optimal (or at least improved) Q value that is expected discounted accumulative reward. Through iterative training, the alert policy model becomes more effective at capturing potential failures and determining the appropriate action to take. In one aspect, the model evaluation & deployment component 765 may evaluate the alert policy model's performance using metrics such as precision, recall, and inspection redundancy, and determine if the model is ready for deployment. Upon successful evaluation, the component 765 may oversee the deployment of the model for real-time use in monitoring airplane components and generating alerts. After deployment, the data preprocessing component 750 may continue to collect data from operational use, including new flight records and interaction records and output clean data that can be used by reinforcement learning engine 755 and model training & optimization component 760 to update the environment models and retrain the policy model.

In the illustrated example, the storage 715 may include a variety of data for effective operation and continuous improvement of the airplane component failure prognostic system. The data may include, but is not limited to, historical flight records, historical airline response records, environment models used in reinforcement learning process, trained policy models, and logs of model's performance metrics (e.g., precision, recall and inspection redundancy). In some aspects, the aforementioned data may be saved in a remote database that connects to the computing device 700 via a network (e.g., the Internet).

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

1. A method, comprising:
preprocessing flight data to identify a plurality of parameters representing operational characteristics of an airplane component;
formulating, based on the preprocessed flight data, a reinforcement learning framework for airplane component failure prognostics, comprising:
defining a state representation as an input to a policy model, wherein the state representation comprises one or more parameters from the plurality of parameters;
determining an action of sending an inspection alert or not, by the policy model, based on the state representation;
modeling one or more system behaviors in response to the action using preprocessed flight data;
calculating a reward for the action under the state representation using a predefined reward structure; and
collecting training data by simulating an airplane component failure prognostic procedure;
training the policy model using a learning and optimization algorithm with the training data to increase an expected discounted cumulative reward by choosing the action under the state representation, wherein training the policy model includes iteratively adjusting internal parameters of the policy model by performing gradient-based optimization to reduce an error between an estimated Q value and an optimal Q value; and
deploying the policy model in a real-time prognostic environment, wherein the deploying comprises:
receiving state data representing real-time operational characteristics of the airplane component; and
outputting the action of sending the inspection alert for the airplane component based at least in part on the state data.

2. The method of claim 1, wherein training the policy model comprises:
given the training data, estimating the expected discounted cumulative reward under the state representation for two actions, wherein a first action comprises sending the inspection alert, and a second action comprises not sending the inspection alert; and
performing the gradient-based optimization to adjust the policy model to select the action with a higher expected discounted cumulative reward under the state representation.

3. The method of claim 2, wherein the policy model comprises a neural network architecture that comprises a recurrent layer, one or more fully connected layers, and an output layer.

4. The method of claim 3, wherein performing the gradient-based optimization comprises adjusting one or more weights of nodes within the recurrent layer or the one or more fully connected layers to increase a likelihood of selecting the action with a higher expected discounted cumulative reward under the state representation.

5. The method of claim 1, wherein the one or more system behaviors comprises at least one of:
(i) scheduling an inspection in response to receiving the inspection alert;
(ii) not scheduling an inspection in response to receiving the inspection alert;
(iii) delaying the inspection for a number of days after the inspection is scheduled;
(iv) generating a positive inspection result indicating that the airplane component needs to be replaced or maintained;
(v) generating a negative inspection result indicating that no replacement or maintenance is needed for the airplane component; and
(vi) transiting to a new state of the airplane component based on a current state of the airplane component and whether replacement is performed or not.

6. The method of claim 1, wherein the plurality of parameters identified from preprocessing the flight data comprise at least one of:
(i) sensor data indicative of an operational status of the airplane component;
(ii) a number of days since a last removal of the airplane component;
(iii) a number of days until a next scheduled removal of the airplane component;
(iv) a failure prediction label generated by a prediction model;
(v) one or more flight records associated with an aircraft comprising the airplane component;
(vi) one or more alert times indicating when inspection alerts were sent;
(vii) one or more inspection schedules indicating when inspections were scheduled;
(viii) one or more inspection records indicating when the inspections were performed; and
(ix) one or more inspection records indicating results of the inspections, including whether the airplane component requires replacement or maintenance.

7. The method of claim 1, further comprising evaluating a performance of the policy model using at least one of:
a ratio between a number of successful inspection alerts and a total number of inspection alerts generated by the policy model,
a ratio between a number of airplane component failures that are successfully alerted and a total number of airplane component failures, or
a ratio between a number of unnecessary inspection alerts and a total number of inspections conducted.

8. The method of claim 1, wherein deploying the policy model in the real-time prognostic environment, further comprises:
collecting data on one or more responses from one or more airlines and one or more airplane component statuses after executing the action;
updating one or more system models based on the collected data; and
refining the policy model based on the collected data.

9. A system, comprising:
one or more memories collectively containing one or more programs; and
one or more computer processors, wherein the one or more computer processors are configured to, individually or collectively, perform an operation, the operation comprising:
preprocessing flight data to identify a plurality of parameters representing operational characteristics of an airplane component;
formulating, based on the preprocessed flight data, a reinforcement learning framework for airplane component failure prognostics, comprising:
defining a state representation as an input to a policy model, wherein the state representation comprises one or more parameters from the plurality of parameters;
determining an action of sending an inspection alert or not, by the policy model, based on the state representation;
modeling one or more system behaviors in response to the action using preprocessed flight data;
calculating a reward for the action under the state representation using a predefined reward structure; and
collecting training data by simulating an airplane component failure prognostic procedure;
training the policy model using a learning and optimization algorithm with the training data to increase an expected discounted cumulative reward by choosing the action under the state representation, wherein training the policy model includes iteratively adjusting internal parameters of the policy model by performing gradient-based optimization to reduce an error between an estimated Q value and an optimal Q value; and
deploying the policy model in a real-time prognostic environment, wherein the deploying comprises:
receiving state data representing real-time operational characteristics of the airplane component; and
outputting the action of sending the inspection alert for the airplane component based at least in part on the state data.

10. The system of claim 9, wherein, to train the policy model, the one or more computer processors are configured to, individually or collectively, perform the operation comprising:
given the training data, estimating the expected discounted cumulative reward under the state representation for two actions, wherein a first action comprises sending the inspection alert, and a second action comprises not sending the inspection alert; and
performing the gradient-based optimization to adjust the policy model to select the action with a higher expected discounted cumulative reward under the state representation.

11. The system of claim 10, wherein the policy model comprises a neural network architecture that comprises a recurrent layer, one or more fully connected layers, and an output layer.

12. The system of claim 11, wherein, to perform the gradient-based optimization, the one or more computer processors are configured to, individually or collectively, perform the operation comprising:
adjusting one or more weights of nodes within the recurrent layer or the one or more fully connected layers to increase a likelihood of selecting the action with a higher expected discounted cumulative reward under the state representation.

13. The system of claim 9, wherein the one or more system behaviors comprises at least one of:
(i) scheduling an inspection in response to receiving the inspection alert;
(ii) not scheduling an inspection in response to receiving the inspection alert;
(iii) delaying the inspection for a number of days after the inspection is scheduled;
(iv) generating a positive inspection result indicating that the airplane component needs to be replaced or maintained;
(v) generating a negative inspection result indicating that no replacement or maintenance is needed for the airplane component; and
(vi) transiting to a new state of the airplane component based on a current state of the airplane component and whether replacement is performed or not.

14. The system of claim 9, wherein the plurality of parameters identified from preprocessing the flight data comprise at least one of:
(i) sensor data indicative of an operational status of the airplane component;
(ii) a number of days since a last removal of the airplane component;
(iii) a number of days until a next scheduled removal of the airplane component;
(iv) a failure prediction label generated by a prediction model;
(v) one or more flight records associated with an aircraft comprising the airplane component;
(vi) one or more alert times indicating when inspection alerts were sent;
(vii) one or more inspection schedules indicating when inspections were scheduled;
(viii) one or more inspection records indicating when the inspections were performed; and
(ix) one or more inspection records indicating results of the inspections, including whether the airplane component requires replacement or maintenance.

15. The system of claim 9, wherein the one or more computer processors are configured to, individually or collectively, perform the operation further comprising evaluating a performance of the policy model using at least one of:
a ratio between a number of successful inspection alerts and a total number of inspection alerts generated by the policy model,
a ratio between a number of airplane component failures that are successfully alerted and a total number of airplane component failures, or
a ratio between a number of unnecessary inspection alerts and a total number of inspections conducted.

16. The system of claim 9,
wherein deploying the policy model in the real-time prognostic environment further comprises:
collecting data on one or more responses from one or more airlines and one or more airplane component statuses after executing the action;
updating one or more system models based on the collected data; and
refining the policy model based on the collected data.

17. One or more non-transitory computer-readable media containing, in any combination, computer program code that, when executed by a computer system, performs an operation comprising:
preprocessing flight data to identify a plurality of parameters representing operational characteristics of an airplane component;
formulating, based on the preprocessed flight data, a reinforcement learning framework for airplane component failure prognostics, comprising:
defining a state representation as an input to a policy model, wherein the state representation comprises one or more parameters from the plurality of parameters;
determining an action of sending an inspection alert or not, by the policy model, based on the state representation;
modeling one or more system behaviors in response to the action using preprocessed flight data;
calculating a reward for the action under the state representation using a predefined reward structure; and
collecting training data by simulating an airplane component failure prognostic procedure;
training the policy model using a learning and optimization algorithm with the training data to increase an expected discounted cumulative reward by choosing the action under the state representation, wherein training the policy model includes iteratively adjusting internal parameters of the policy model by performing gradient-based optimization to reduce an error between an estimated Q value and an optimal Q value; and
deploying the policy model in a real-tim pronostic environment, wherein the deplying comprises:
receiving state data representing real-time operational characteristics of the airplane component; and
ouputting the action of sending the inspection alert for the airplane component base at least in part on the state data.

18. The one or more non-transitory computer-readable media of claim 17, wherein, to train the policy model, the computer program code that, when executed by the computer system, performs the operation comprising:
given the training data, estimating the expected discounted cumulative reward under the state representation for two actions, wherein a first action comprises sending the inspection alert, and a second action comprises not sending the inspection alert; and
performing the gradient-based optimization to adjust the policy model to selection the action with a higher expected discounted cumulative reward under the state representation.

19. The one or more non-transitory computer-readable media of claim 18, wherein the policy model comprises a neural network architecture that comprises a recurrent layer, one or more fully connected layers, and an output layer.

20. The one or more non-transitory computer-readable media of claim 19, wherein, to perform the gradient-based optimization, the computer program code that, when executed by the computer system, performs the operation comprising adjusting one or more weights of nodes within the recurrent layer or the one or more fully connected layers to increase a likelihood of selectin the action with a higher expected discounted cumulative reward under the state representation.
